(19) United States
(12) Patent Application Publication
(10) Pub. No.: US 2008/0012510 A1
(43) Pub. Date: Jan. 17, 2008

(54) Backlight module and digital programmable control circuit thereof

(75) Inventor: Tai-Sheng Po, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/812,654

(22) Filed: Jun. 20, 2007

(30) Foreign Application Priority Data
Jul. 17, 2006 (TW) 095126097

(51) Int. Cl. H05B 41/36; G05F 1/10

(52) U.S. Cl. 315/308

(57) ABSTRACT

A digital programmable control circuit of a backlight module for controlling a lamp circuit includes a memory unit, a processing unit and a pulse width modulation (PWM) unit. The memory unit stores a lamp parameter. The processing unit electrically connected to the memory unit reads the lamp parameter. The PWM unit is electrically connected to the processing unit. The processing unit controls the PWM unit to generate a PWM signal for controlling the lamp circuit according to the lamp parameter.

### CROSS REFERENCE TO RELATED APPLICATIONS

This Non-provisional application claims priority under 35 U.S.C. §119(a) on Patent Application No(s). 095126097 filed in Taiwan, Republic of China on Jul. 17, 2006, the entire contents of which are hereby incorporated by reference.

### BACKGROUND OF THE INVENTION

1. Field of Invention

The invention relates to a backlight module and a control circuit thereof, and, in particular, to a backlight module having a digital programmable control circuit.

2. Related Art

Recently, the flat panel displays are getting more and more popular, and the liquid crystal display (LCD) has become a mainstream in the market. The LCD includes a LCD panel and a backlight module. The backlight module provides a light source so that the LCD panel displays an image. Currently, the backlight module includes a cold cathode fluorescent lamp (CCFL) serving as the light source, and an inverter for driving the CCFL to emit light.

Referring to FIG. 1, a conventional inverter 1 of a backlight module includes a control circuit 11, a power switching circuit 12, a transformer 13, a voltage feedback circuit 14, a current feedback circuit 15, a dimming control circuit 16 and a switch control circuit 17.

The control circuit 11 is an application specific integrated circuit (ASIC) used for an CCFL inverter for outputting a pulse width modulation (PWM) signal S_{PWM} to the power switching circuit 12 according to working frequencies required by different lamps. Therefore, the power switching circuit 12 is controlled to rapidly switch an inputted DC voltage with the high frequency (40 to 80 KHz) and thus to convert the DC voltage into high-frequency pulses. The duty cycle of the frequency of the high-frequency pulses is controlled by the PWM signal S_{PWM}.

The high-frequency pulses are inputted to the transformer 13, which outputs a high voltage to drive a lamp 2 to emit light. The voltage feedback circuit 14 and the current feedback circuit 15 respectively measure an output voltage of the transformer 13 and a driving current of the lamp 2, and output the measured results to the control circuit 11 for the feedback control. The dimming control circuit 16 and the switch control circuit 17 respectively output a dimming signal S_{ADJ} and a switching signal S_{ON/OFF} so as to control the PWM signal S_{PWM} generated by the control circuit 11. The luminance of the lamp 2 is adjusted according to the dimming signal S_{ADJ}, and whether the operation of the inverter 1 is set according to the switching signal S_{ON/OFF}.

However, in the inverter 1, most circuits have to be set according to the specification specified by the lamp 2. For example, the output current and the output voltage of the control circuit 11 have to fall within an allowable range of the specification, or the voltage feedback circuit 14 and the current feedback circuit 15 have to design the working point of the circuit according to the lamp 2. Thus, the circuits have to be pre-designed according to the specific lamp specification and property so as to generate the predetermined output voltage or current. If the backlight module or the lamp 2 has the material variation or the human production variation to cause the property variation of the lamp 2 to become too great, the inverter 1 only can respond with the originally designed working condition. Therefore, the optical property of the lamp 2 cannot be fixed effectively.

In addition, the inverter 1 makes a detailed circuit adjustment according to the specific backlight module and system. If the lamp 2 fluctuates, the control circuit in the inverter 1 has to be modified to correct the lamp current, the lamp frequency, the lamp enable voltage, the lamp operation voltage, the protection circuit working point, and the like. Even if the same circuits are used, the circuit parameter (e.g., resistance, capacitance and inductance) also have to be designed and adjusted again.

Therefore, it is an important subject to provide a lamp driving circuit that can avoid the above mentioned problems and improve the previously mentioned drawbacks.

### SUMMARY OF THE INVENTION

In view of the foregoing, the invention is to provide a backlight module for the storing parameter and a digital programmable control circuit thereof.

To achieve the above, the invention discloses a digital programmable control circuit of a backlight module for controlling a lamp circuit of the backlight module. The digital programmable control circuit includes a memory unit, a processing unit and a pulse width modulation (PWM) unit. The memory unit stores a lamp parameter. The processing unit is electrically connected to the memory unit for reading the lamp parameter. The PWM unit is electrically connected to the processing unit. The processing unit controls the PWM unit according to the lamp parameter to generate a PWM signal for controlling the lamp circuit.

To achieve the above, the invention discloses a digital programmable control circuit of a backlight module. The digital programmable control circuit controls a lamp circuit and is programmed by an external circuit. The digital programmable control circuit includes a memory unit, a processing unit, a PWM unit and a communication unit. The memory unit stores a lamp parameter. The processing unit is electrically connected to the memory unit for reading the lamp parameter. The PWM unit is electrically connected to the processing unit. The processing unit controls the PWM unit according to the lamp parameter to generate a PWM signal to control the lamp circuit. The communication unit is electrically connected to the processing unit and the external circuit, and enables the processing unit and the external circuit to exchange data.

To achieve the above, the invention further discloses a backlight module including a lamp, a digital programmable control circuit and a driving circuit. The digital programmable control circuit has a memory unit, a processing unit and a PWM unit. The memory unit stores a lamp parameter. The processing unit is electrically connected to the memory unit and reads the lamp parameter. The PWM unit is electrically connected to the processing unit. The processing unit controls the PWM unit according to the lamp parameter to generate a PWM signal. The driving circuit is electrically connected to the PWM unit for driving the lamp according to the PWM signal.

As mentioned above, the backlight module and the digital programmable control circuit thereof according to the invention have the memory unit for recording the parameter and the associated program codes for driving the lamp circuit. Compared to the prior art, when the backlight module of the invention or the specification of the lamp circuit is changed, only the lamp parameter stored in the memory unit has to be modified, and it is unnecessary to modify the lamp circuit or its associated circuits significantly. Thus, the research and development time and the cost may be reduced, the digital programmable control circuit is also more adapted to the diversified products, and the circuits and the elements can be easily standardized to enhance the flexibility in production.

### BRIEF DESCRIPTION OF THE DRAWINGS

The invention will become more fully understood from the detailed description given herein below illustration only, and thus is not limitative of the present invention, and wherein:

FIG. 1 is a block diagram showing a conventional inverter of a backlight module;

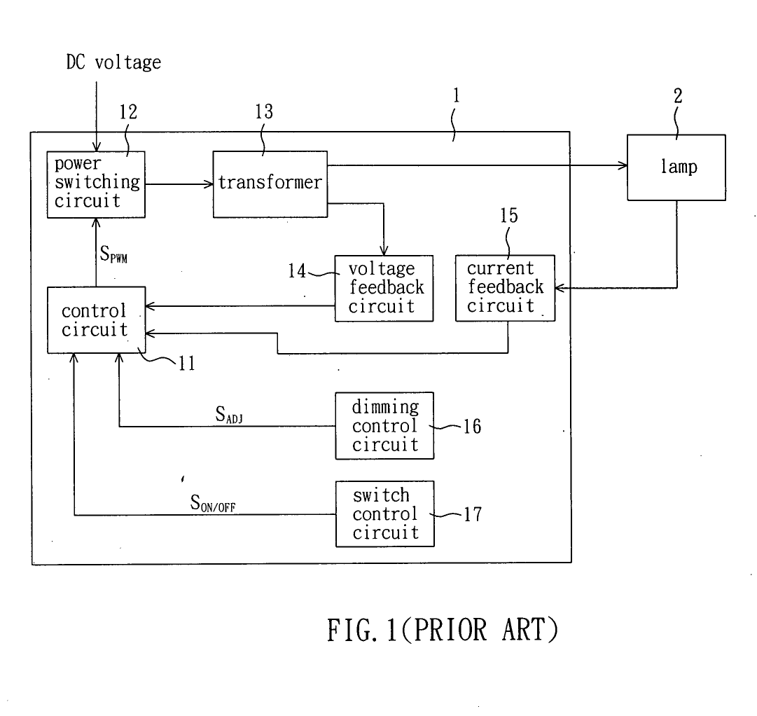

FIG. 2 is a block diagram showing a backlight module according to an embodiment of the invention;

FIG. 3 is a block diagram showing a backlight module according to another embodiment of the invention; and

FIGS. 4 to 5 are block diagrams showing different connections between the transformer and the current feedback circuit according to the embodiment of the invention.

### DETAILED DESCRIPTION OF THE INVENTION

The present invention will be apparent from the following detailed description, which proceeds with reference to the accompanying drawings, wherein the same references relate to the same elements.

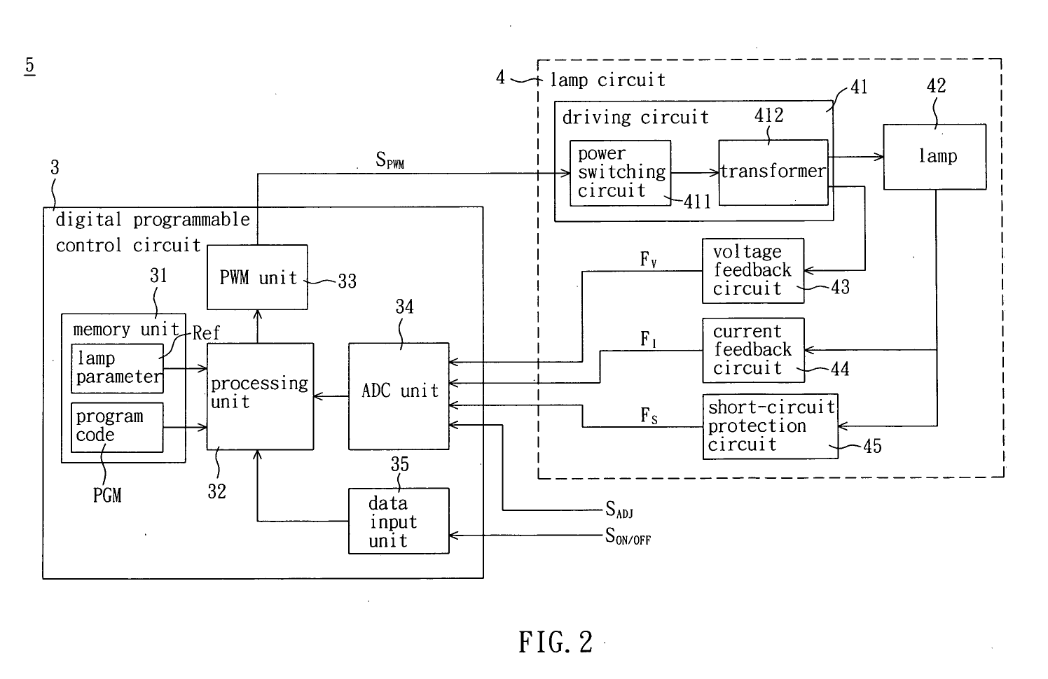

Referring to FIG. 2, a digital programmable control circuit 3 of a backlight module 5 according to an embodiment of the invention is for controlling a lamp circuit 4 of the backlight module 5. The digital programmable control circuit 3 includes a memory unit 31, a processing unit 32, a PWM unit 33, an analog-to-digital converting unit (ADC unit) 34 and a data input unit 35. The memory unit 31 stores a lamp parameter Ref. The processing unit 32 is electrically connected to the memory unit 31 and reads the lamp parameter Ref. The PWM unit 33 is electrically connected to the processing unit 32, which controls the PWM unit 33 according to the lamp parameter Ref to generate a PWM signal S_{PWM} for controlling the lamp circuit 4.

The lamp parameter Ref record important parameter of the backlight module 5 and inner circuits thereof. The digital programmable control circuit 3 can perform the compensation and the adjustment according to the lamp parameter Ref so that the property of the backlight module 5 is optimized.

The memory unit 31 stores a program code PGM, and the processing unit 32 executes the program code PGM to control the PWM unit 33 according to the lamp parameter Ref to generate the PWM signal S_{PWM}.

The ADC unit 34 is electrically connected to the lamp circuit 4 and converts a feedback signal of the lamp circuit 4. The feedback signal may be a voltage feedback signal or a current feedback signal. The processing unit 32 is electrically connected to the ADC unit 34 and controls the PWM unit 33 to adjust the PWM signal S_{PWM} according to the converted feedback signal. If the lamp circuit 4 needs a larger output power, the processing unit 32 controls the PWM unit 33 to broaden the duty cycle of the PWM signal S_{PWM}. If the output power has to be reduced, the duty cycle of the PWM signal S_{PWM} may be shortened.

The digital programmable control circuit 3 has the memory unit 31 for recording the parameter and associated program codes for driving the lamp circuit 4. Thus, if the specifications and uses of the backlight module 5 and the lamp circuit 4 change or the liquid crystal panel used in conjunction with the backlight module 5 changes, only the lamp parameter Ref stored in the memory unit 31 have to be corrected without greatly correcting the lamp circuit 4 or the hardware circuits in conjunction with the lamp circuit 4. Thus, the research and development cost can be reduced. The digital programmable control circuit 3 is also more adapted to the diversified products, and can reduce the development time and cost so that the circuits and the elements may be easily standardized and the flexibility in production can be increased.

In this embodiment, the lamp circuit 4 includes a driving circuit 41, a lamp 42, a voltage feedback circuit 43, a current feedback circuit 44 and a short-circuit protection circuit 45. The driving circuit 41 includes a power switching circuit 411 and a transformer 412, which has a primary side and a secondary side. Each of the primary side and the secondary side has a primary coil and a secondary coil. The power switching circuit 411 is electrically connected to the PWM unit 33 and controls an output voltage and an output current of the transformer 412 according to the PWM signal S_{PWM} to drive the lamp 42. The voltage feedback circuit 43 is electrically connected to the secondary side of the transformer 412 of the driving circuit 41, and measures a driving voltage of the lamp 42 to generate a feedback signal F_{V}. The current feedback circuit 44 is electrically connected to the lamp 42, and measures a driving current of the lamp 42 to generate a feedback signal F₁. The short-circuit protection circuit 45 is electrically connected to the lamp 42 and measures the driving current of the lamp 42 to generate a feedback signal F_{S}.

The circuits other than the lamp 42 in the lamp circuit 4 may be implemented in an inverter together with the digital programmable control circuit 3. The important circuit parameter in the inverter are stored in the lamp parameter Ref of the memory unit 31 in a programmable manner or directly set in the program code PGM.

The ADC unit 34 is electrically connected to the voltage feedback circuit 43 and the current feedback circuit 44 and controls the PWM unit 33 to adjust the PWM signal S_{PWM} according to the converted feedback signals F_{V} and F₁, respectively.

In addition, a dimming signal S_{ADJ} is adopted to set polarity changes of a PWM dimming (digital dimming) and an analog dimming (positive dimming or negative dimming) and a dimming linear variation rate. A switching signal S_{ON/OFF} is adopted to control the inverter to operate or not.

If the dimming signal S_{ADJ} is the DC signal, the ADC unit 34 can receive the dimming signal S_{ADJ} and convert the dimming signal S_{ADJ} into a digital signal. Then, the processing unit 32 controls the PWM unit 33 according to the converted dimming signal S_{ADJ} to adjust the PWM signal S_{PWM}.

The ADC unit 34 converts the feedback signal of the lamp circuit 4 into a digital signal, or converts other control signals into digital signals so that the processing unit 32 can process the digital signal or signals. The digital programmable control circuit 3 processes the voltage and the current required by the lamp circuit 4 in a digital manner.

The data input unit 35 receives the switching signal S_{ON/OFF}, wherein the processing unit 32 is electrically connected to the data input unit 35 and controls the PWM unit 33 to output the PWM signal S_{PWM} or not according to the switching signal S_{ON/OFF}.

The memory unit 31 stores the lamp parameter Ref including an output current setting value, an output voltage setting value, an over-voltage point setting value, a lamp open-circuit protection setting value, a lamp short-circuit protection setting value, a working frequency setting value, a driving circuit setting value, a dimming manner setting value, a dimming signal varying value, and the like. The level of the feedback signal F_{V} is higher when the output voltage of the driving circuit 41 or the driving voltage of the lamp 42 is higher, and the level of the feedback signal F₁ is higher when the output current of the driving circuit 41 or the driving current of the lamp 42 is larger.

The output current setting value and the over-voltage point setting value are utilized to set the values of the current and the voltage for driving the lamp 42, respectively, and may be properly adjusted according to various current or voltage specifications of various lamps.

The processing unit 32 may judge whether the driving current of the lamp 42 reaches the output current setting value according to the feedback signal F₁. If the feedback signal F₁ is smaller than the output current setting value, the processing unit 32 controls the PWM unit 33 to increase the duty cycle of the PWM signal S_{PWM} so that the output current of the driving circuit 41 is increased and the current for driving the lamp 42 is increased.

In addition, the processing unit 32 may judge whether the driving voltage of the lamp 42 reaches the output voltage setting value according to the feedback signal F_{V}. If the feedback signal F_{V} is greater than the output voltage setting value, the processing unit 32 controls the PWM unit 33 to reduce the duty cycle of the PWM signal S_{PWM} so that the output voltage of the driving circuit 41 is reduced and the voltage for driving the lamp 42 is reduced.

The over-voltage point setting value is utilized to set a protection point of the highest output voltage of the driving circuit 41. The processing unit 32 may judge whether the output voltage of the driving circuit 41 is too high according to the feedback signal F_{V}. If the feedback signal F_{V} is greater than the over-voltage point setting value, the processing unit 32 controls the PWM unit 33 to reduce the duty cycle of the PWM signal S_{PWM} so that the output voltage of the driving circuit 41 is decreased to prevent the too-high voltage from damaging the lamp 42.

The lamp open-circuit protection setting value and the lamp short-circuit protection setting value are utilized to set an open-circuit protection point and a short-circuit protection point of the lamp 42, respectively. The processing unit 32 may judge whether the lamp 42 is short-circuited or open-circuited and is not electrically connected to the driving circuit 41 according to the feedback signal F_{S}. When the feedback signal F_{S} exceeds the lamp open-circuit protection setting value, or when the feedback signal F_{S} exceeds the lamp short-circuit protection setting value, the processing unit 32 turns off the circuit in the backlight module 5 to prevent the damage from being caused.

The working frequency setting value is utilized to set the working frequency of the driving circuit in correspondence with various lamp specifications. The processing unit 32 controls the PWM unit 33 to generate the PWM signal S_{PWM} according to the working frequency setting value.

The driving circuit setting value is utilized to set the ratio of the ON period to the OFF period of the driving circuit 41. The processing unit 32 controls the PWM unit 33 to generate the PWM signal S_{PWM} according to the driving circuit setting value so that the switching operation of the driving circuit reaches a stable state.

The dimming manner setting value is utilized to set the polarity change of the PWM dimming (digital dimming), the polarity change of the analog dimming (positive dimming or negative dimming) and the dimming linear variation rate. The dimming signal varying value is utilized to set the polarity change (positive dimming or negative dimming) of dimming, the dimming linear variation rate and the dimming range. The processing unit 32 controls the PWM unit 33 to adjust the duty cycle, the amplitude or the frequency of the PWM signal S_{PWM} according to the dimming signal S_{ADJ}, the dimming manner setting value and the dimming signal varying value.

The memory unit 31 may be implemented as a non-volatile memory or a programmable memory, such as a programmable read only memory (ROM), an electrically erasable read only memory (EEPROM) or a flash memory. The stored contents of the memory unit 31 may be modified so that the lamp parameter Ref may be updated in correspondence with the changes of the internal circuits or specifications of the backlight module 5 and the circuit design may become more flexible. The digital programmable control circuit 3 may be implemented as a microcontroller, the processing unit 32 may be implemented as a microprocessor, and the memory unit 31 may be implemented in the microcontroller.

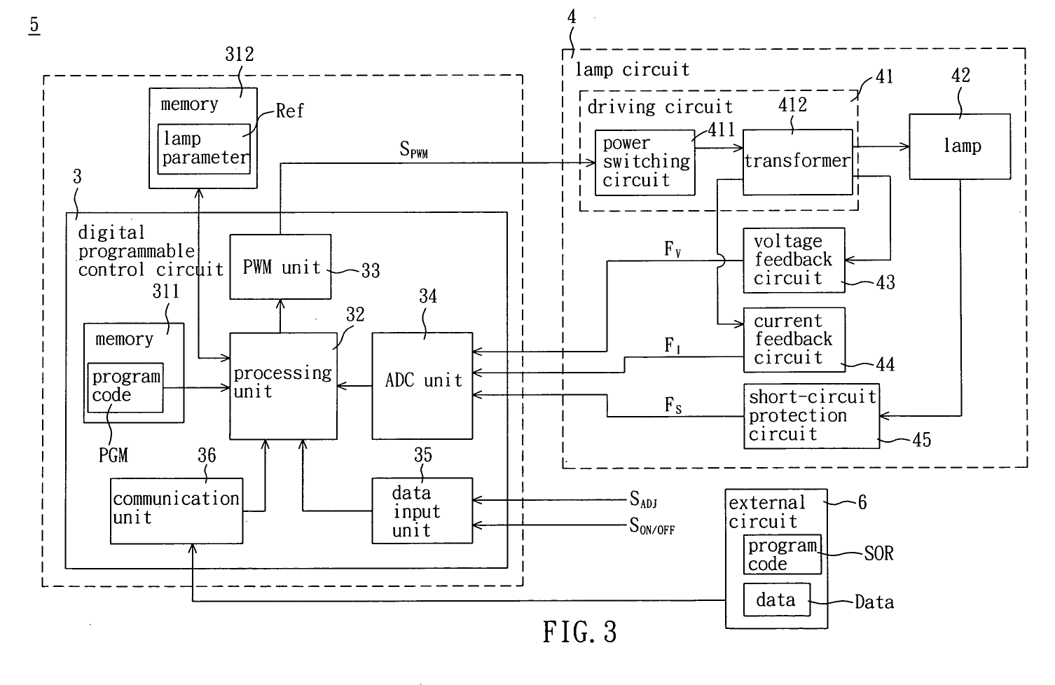

Referring to FIG. 3, what is different from FIG. 2 is that the digital programmable control circuit 3 further includes a communication unit 36, which is electrically connected to the processing unit 32 and an external circuit 6, for enabling the processing unit 32 and the external circuit 6 to exchange data with each other. The communication unit 36 receives a program code SOR from the external circuit 6. The processing unit 32 writes the program code SOR into the memory unit 31 and stores the program code SOR as the program code PGM, and then the processing unit 32 executes the program code PGM to control the PWM unit 33 to generate the PWM signal S_{PWM} according to the lamp parameter Ref. In addition, if the interior of the backlight module 5 is designed again or the circuit is modified, the program code PGM may also be updated by way of writing. Furthermore, the data input unit 35 may also receive the program code SOR, and the processing unit 32 writes the program code SOR from the data input unit 35 into the memory unit 31 as the program code PGM.

The communication unit 36 receives data Data from the external circuit 6, and the processing unit 32 updates the lamp parameter Ref according to the data Data. Thus, various control parameter of the inverter may be individually set/stored/modified in the lamp parameter Ref of the memory unit 31 by the external circuit 6.

The communication unit 36 transmits the data in a bi-directional and serial manner and transmits the parameter and the data of the backlight module 5 and its internal circuits, which are detected by the digital programmable control circuit 3, to the external circuit 6 for the purpose of judgment and record. The external circuit 6 may be implemented as a controller or a micro-computer.

In addition, if the dimming signal S_{ADJ} is a pulse-width-modulated signal, the data input unit 35 may receive the dimming signal S_{ADJ}, wherein the processing unit 32 is electrically connected to the data input unit 35 and controls the PWM unit 33 to adjust the PWM signal S_{PWM} according to the dimming signal S_{ADJ}.

Furthermore, the memory unit 31 includes two memories 311 and 312, wherein the memory 311, the processing unit 32, the PWM unit 33, the ADC unit 34, the data input unit 35 and the communication unit 36 are implemented in the microcontroller. The memory 311 is a non-volatile memory, such as a ROM, which stores the program code PGM that is not often modified and is usually built in the typical microcontroller. The memory 312 is implemented as a non-volatile memory, such as a flash memory, which is disposed outside the microcontroller and stores the lamp parameter Ref, which is often modified.

In addition, because the feedback signal F_{S} outputted from the short-circuit protection circuit 45 is similar to the digital signal, the data input unit 35 may be directly electrically connected to the short-circuit protection circuit 45, and it is unnecessary to convert the feedback signal F_{S} into the digital signal using the ADC unit 34. The feedback signal F_{S} is transmitted to the processing unit 32 through the data input unit 35. Because the aspect of this example differs from FIG. 3 only in that the feedback signal F_{S} is inputted to the data input unit 35, so no drawing is illustrated.

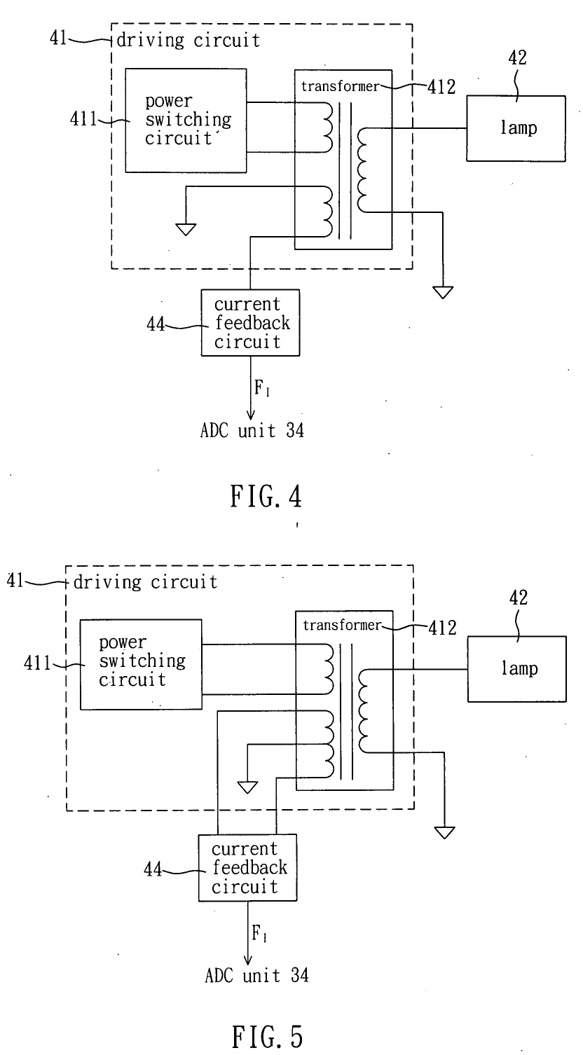

The current feedback circuit 44 is electrically connected to the primary side of the transformer 412 of the driving circuit 41, and measures the current outputted from the power switching circuit 411 to the transformer 412 to generate the feedback signal F₁. Because the transformer 412 is changed, the current feedback circuit 44 and the transformer 412 are also changed according to FIGS. 4 and 5.

As shown in FIG. 4, the transformer 412 is additionally wound with a coil in parallel with the primary coil, and the current feedback circuit 44 converts the voltage of the parallel winding into a current feedback signal serving as the feedback signal F₁. As shown in FIG. 5, the transformer 412 is additionally wound with a coil in parallel with the primary coil, and the parallel winding has a central tap winding structure. The current feedback circuit 44 is connected to two terminals of the parallel winding and thus converts the voltage of the parallel winding into the current feedback signal serving as the feedback signal F₁.

In summary, the backlight module and the digital programmable control circuit thereof according to the invention have the memory unit for recording the parameter and the associated program codes necessary for driving the lamp circuit. Compared with the prior art, when the backlight module of the invention or the specification of the lamp circuit is changed, only the lamp parameter stored in the memory unit has to be modified, and it is unnecessary to modify the lamp circuit or its associated circuits significantly. Thus, the research and development time and cost may be reduced, the digital programmable control circuit is also more adapted to the diversified products, and the circuits and the elements can be easily standardized to enhance the flexibility in production.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A digital programmable control circuit of a backlight module for controlling a lamp circuit of the backlight module, the digital programmable control circuit comprising:
a memory unit for storing a lamp parameter;
a processing unit electrically connected to the memory unit for reading the lamp parameter; and
a pulse width modulation (PWM) unit electrically connected to the processing unit, wherein the processing unit controls the PWM unit according to the lamp parameter to generate a PWM signal to control the lamp circuit.

2. The control circuit according to claim 1, further comprising:
an analog-to-digital converting unit electrically connected to the lamp circuit and converts a feedback signal of the lamp circuit, wherein the processing unit is electrically connected to the analog-to-digital converting unit and controls the PWM unit according to the converted feedback signal to adjust the PWM signal.

3. The control circuit according to claim 2, wherein the lamp circuit comprises:
a lamp;
a driving circuit electrically connected to the PWM unit for driving the lamp according to the PWM signal; and
a voltage feedback circuit electrically connected to the driving circuit for measuring a driving voltage of the lamp to generate the feedback signal.

4. The control circuit according to claim 2, wherein the lamp circuit comprises:
a lamp;
a driving circuit electrically connected to the PWM unit for driving the lamp according to the PWM signal; and
a current feedback circuit electrically connected to the lamp or the driving circuit for measuring a current of the lamp or the driving circuit to generate the feedback signal.

5. The control circuit according to claim 4, wherein the driving circuit comprises a transformer, comprising:
a primary winding;
a secondary winding; and
a parallel winding connected to the primary coil in parallel, wherein the current feedback circuit is electrically connected to the parallel winding, and measures a current of the parallel winding to generate a current feedback signal.

6. The control circuit according to claim 5, wherein the parallel winding has a central tap winding structure.

7. The control circuit according to claim 2, wherein the analog-to-digital converting unit receives and converts a dimming signal or a DC signal, and the processing unit controls the PWM unit according to the converted dimming signal or the converted DC signal to adjust the PWM signal.

8. The control circuit according to claim 2, wherein the lamp circuit comprises:
a lamp;
a driving circuit electrically connected to the PWM unit for driving the lamp according to the PWM signal; and
a short-circuit protection circuit electrically connected to the lamp for measuring a driving current of the lamp to generate the feedback signal, wherein the analog-to-digital converting unit is electrically connected to the short-circuit protection circuit and converts the feedback signal, and the processing unit is electrically connected to the analog-to-digital converting unit, and determines whether the lamp is short-circuited or open-circuited according to the converted feedback signal.

9. The control circuit according to claim 1, further comprising a data input unit, wherein the lamp circuit comprises:
a lamp;
a driving circuit electrically connected to the PWM unit for driving the lamp according to the PWM signal; and
a short-circuit protection circuit electrically connected to the lamp for measuring a driving current of the lamp to generate a feedback signal, wherein the data input unit is electrically connected to the short-circuit protection circuit and the processing unit, and the processing unit determines whether the lamp is short-circuited or open-circuited according to the converted feedback signal.

10. The control circuit according to claim 1, further comprising:
a data input unit for receiving a dimming signal or a switch signal, wherein the processing unit is electrically connected to the data input unit and controls the PWM unit according to the dimming signal to adjust the PWM signal, or controls the PWM unit to output the PWM signal according to the switching signal.

11. The control circuit according to claim 1, wherein the memory unit stores a program code, and the processing unit executes the program code and controls the PWM unit according to the lamp parameter to generate the PWM signal.

12. The control circuit according to claim 11, further comprising:
a data input unit for receiving the program code, wherein the processing unit is electrically connected to the data input unit to write the program code into the memory unit.

13. The control circuit according to claim 1, further comprising:
a communication unit electrically connected to the processing unit and an external circuit for enabling the processing unit and the external circuit to exchange data.

14. The control circuit according to claim 13, wherein the communication unit receives a program code from the external circuit, and the processing unit writes the program code into the memory unit for storing and executing the program code to control the PWM unit according to the lamp parameter to generate the PWM signal.

15. The control circuit according to claim 13, wherein the communication unit receives data from the external circuit, and the processing unit updates the lamp parameter according to the data.

16. The control circuit according to claim 1, wherein the digital programmable control circuit is a microcontroller, and the memory unit is a non-volatile memory.

17. The control circuit according to claim 1, wherein the lamp parameter is an output current setting value, an output voltage setting value, an over-voltage point setting value, a lamp open-circuit protection setting value, a lamp short-circuit protection setting value, a working frequency setting value, a driving circuit setting value, a dimming manner setting value or a dimming signal varying value.

18. The control circuit according to claim 1, wherein the memory unit is a non-volatile memory, a programmable read only memory (ROM), an electrically erasable read only memory (EEPROM) or a flash memory.

19. The control circuit according to claim 1, wherein the lamp circuit is programmed by an external circuit, and the digital programmable control circuit further comprises a communication unit electrically connected to the processing unit and the external circuit for enabling the processing unit and the external circuit to exchange data

20. The control circuit according to claim 19, wherein the communication unit receives a data or a program code from the external circuit, the processing unit updates the lamp parameter according to the data, or the processing unit writes the program code into the memory unit for storing.

21. A backlight module, comprising:
a lamp;
a digital programmable control circuit having a memory unit, a processing unit and a pulse width modulation (PWM) unit, wherein the memory unit stores a lamp parameter, the processing unit is electrically connected to the memory unit and reads the lamp parameter, the PWM unit is electrically connected to the processing unit, and the processing unit controls the PWM unit according to the lamp parameter to generate a PWM signal; and
a driving circuit electrically connected to the PWM unit and driving the lamp according to the PWM signal.
